(19) United States
(12) Patent Application Publication
(10) Pub. No.: US 2017/0053321 A1
(43) Pub. Date: Feb. 23, 2017

(54) ONLINE ADVERTISEMENT METHOD AND SYSTEM THEREFOR

(71) Applicant: Bae Rim KIM, Seoul (KR)

(72) Inventor: Bae Rim KIM, Seoul (KR)

(21) Appl. No.: 15/306,785

(22) PCT Filed: Apr. 27, 2015
(86) PCT No.: PCT/KR2015/004164

§ 371 Date: Oct. 26, 2016

(30) Foreign Application Priority Data
Apr. 28, 2014 (KR) 10-2014-0050545

(51) Int. Cl. G06Q 30/02

(52) U.S. Cl. CPC G06Q 30/0273; G06Q 30/0277

(57) ABSTRACT

The present invention relates to an online advertisement method and system therefor. More particularly, it relates to a method and system for providing an advertisement using an advertisement icon on a web page and sharing between a website operator and a member advertisement revenue generated by the member clicking the advertisement. An online advertisement method, whereby advertisement revenue generated by an online advertisement and received from an advertiser is shared with a website operator and a plurality of members, the method is performed by a website operating server and includes: (a) displaying an advertisement icon on an initial online homepage(website); (b) assigning a single advertisement account to a member wanting to receive the advertisement revenue by accessing the homepage (website) through a member terminal and seeing the advertisement; (c) transmitting the advertisement to the advertisement account of the member corresponding to a member range, the member range being a range of members that will see the advertisement required from the advertiser; and (d) outputting the advertisement account of the member to the member terminal when the member terminal has accessed the initial homepage and has clicked the advertisement icon after logging into the homepage.

### TECHNICAL FIELD

The present invention relates to an online advertisement method and system therefor. More particularly, it relates to a method and system for providing an advertisement using an advertisement icon on a web page and sharing between a website M operator and a member advertisement revenue generated by the member clicking the advertisement.

### BACKGROUND ART

Internet users have remarkably increased since the late 1990s. Optical cables that maximize a transmission rate are used in homes, companies, national organizations, etc. and have become a universal communication means representing the 21st century.

Such a new communication environment has provided new services such as e-mail, information retrieval, video content delivery, dialogue and discussion services, video conferencing, online gaming, and online advertisement. In addition, the new communication environment will create a huge combined network era in which new types of services will be continuously introduced.

From among the services that are provided online, an online advertisement method includes the following: a banner ad, a keyword ad, a pop up ad, an email ad, etc. A billing system of the online advertisement includes a cost per click (CPC) method that generates a fee when an advertisement is clicked, a cost per mile (CPM) that generates a fee when a webpage of an advertiser is exposed for a certain time, and a cost per action (CPA) method that generates a fee when a member performs an intended action of the advertiser.

Such online advertisements have made rapid progress in quantity by the remarkable increase of internet users and the active involvement of advertisers. However, in quality, websites are now full of banner ads so the member is forced to see the ads in order to see desired information. Thus, it causes a serious inconvenience to the member.

Also, in a conventional billing system, an advertisement revenue is paid when a member clicks an advertisement. However, there is a problem that most of advertisers have to pay for the clicks made by members that are irrelevant to the advertisement, and thus the advertiser has to pay unnecessary fee.

In addition, contrary to a unidirectional dependent advertisement provided by an of newspaper, broadcasting, etc., the online advertisement is a bidirectional independent advertisement and has an effect only when a member makes an effort to see the advertisement. Although the member makes considerable effort in watching the advertisement, the website operator that provides the advertisement monopolizes the corresponding advertisement revenue.

In addition, in order to actively use the features of online advertisements, from a website such as Gold Bank in the late of 1990 that provides a reward when a member watches an advertisement to AdSense of Google at the present, a business model that provides a reward has constantly developed. However, the member forgoes a reward, or receives a reward when reaching a certain level of reserve, etc. Thus, the reward does not have an actual economic value.

In addition, online advertisements are a new type of advertising wherein bidirectional communication is available between an advertiser and a member. In other words, online advertisements require more member participation, effort, and time, and also require the member to provide his or her knowledge, information, and opinion by taking a survey, etc. However, such advertisements have a limit that the website operator monopolizes the advertisement revenue.

Meanwhile, as prior documents, a method for managing an advertisement managing program providing a reward disclosed in Korean Patent Application Publication No. 10-2006-0080151 and a method for managing an advertisement providing a reward disclosed in Korean Patent Application Publication No. 10-2006-0080152 relate a method and system for providing a reward by seeing an advertisement, and more particularly, relate to a method of managing advertisement, in which a member downloads an advertisement managing program that provides only advertisements providing a reward, inputs an amount of reward that he or she wants to receive by seeing an advertisement in the downloaded program, and thus advertisements without rewards are blocked and the member only receives advertisements that satisfy the inputted reward amount. By using this method, a conventional problem in which a website operator monopolizes an advertisement revenue is solved somewhat. In addition, the member is able to block advertisements without rewards by only receiving advertisements with rewards. Thus, there is an effect of increasing a click rate of advertisements with rewards.

However, the above method is limited to members that have downloaded the program, and although the member receives the reward, the reward has no actual economic value.

As another prior document, a system for an online customized advertisement and a method using the same disclosed in Korean Patent Application Publication No. 10-2011-0062369 relates to a method in which a member receives a reward when he or she watches an advertisement. More particularly, the method refers to a method in which a member downloads an advertisement managing program from a website of an advertisement provider, and receives a reward by clicking an advertisement in which a reward amount is specified in a specific part of a banner ad. The reward amount is saved in the advertisement managing program. Accordingly, an attention of the advertisement provided by the advertisement provider is increased and the member obtains revenue.

However, the above method is also limited to only members that have downloaded the advertisement managing program. In addition, although the member receives the reward, the reward has no actual economic value.

### DISCLOSURE

### Technical Problem

The present invention has been made keeping in mind the above problems occurring in the related art, and an object of the present invention is to provide an online advertisement method and a system therefor in which an advertisement icon is installed in a website and advertisements provided to a member are managed in an integrated manner. Therefore, it may provide a comfortable web searching environment.

In addition, another object of the present invention is to provide an online advertisement method and a system therefor in which an advertisement is provided to only members that are specified by an advertiser.

Further, another object of the present invention is to provide an online advertisement method and a system therefor in which a single advertisement account is assigned to a member, and the member uses the advertisement account for receiving advertisements and checking a sharing amount, and for services such as, managing, keeping and receiving coupons, etc.

Further, another object of the present invention is to provide an online advertisement method and a system therefor in which an advertisement icon displays an advertisement revenue sharing percentage, a total advertisement revenue, and member prize money in a lower part thereof to ensure transparency of advertisement revenue sharing between a website operator and a member.

Further, another object of the present invention is to provide an online advertisement method and a system therefor in which an actual economic value for a member is implemented by providing the member with a coupon that is changed from an advertisement sharing amount and providing prize money by drawing the coupon since a conventional advertisement sharing amount does not have an actual economic value.

Further, another object of the present invention is to provide an online advertisement method and a system therefor in which a coupon is immediately changed to a reserve fund according to a cash conversion request of a member.

Further, another object of the present invention is to provide an online advertisement method and a system therefor in which a coupon is issued by interworking with an authorized lottery system and is used for selecting a prizewinner, and the prizewinner is selected by interworking with the lottery system in order to ensure fairness of the selection.

### Technical Solution

In order to achieve the above object, according to one aspect of the present invention, there is provided an online advertisement method, whereby an advertisement revenue generated by an online advertisement and received from an advertiser is shared with a website operator and a plurality of members, the method is performed by a website operating server and includes:

(a) displaying an advertisement icon on an initial online homepage (website);

(b) assigning a single advertisement account to a member wanting to receive the advertisement revenue by accessing the homepage (website) through a member terminal and seeing the advertisement;

(c) transmitting the advertisement to the advertisement account of the member corresponding to a member range, the member range being notified from the advertiser; and

(d) outputting the advertisement account of the member to the member terminal when the member terminal has accessed the initial homepage and has clicked the advertisement icon after logging into the homepage.

In addition, the method further includes:

(e) making a payment, and issuing and transmitting a coupon to the advertisement account of the member and the member terminal when the advertisement icon is clicked by the member terminal;

(f) selecting a prizewinner by drawing the coupon, and providing a corresponding prize money to the prizewinner; and

(g) changing the coupon to a reserve fund and transferring the changed reserve fund to the advertisement account of the member when receiving a dash conversion request from the member terminal before drawing the coupon.

An online advertisement system according to an embodiment of the present invention, whereby an advertisement revenue generated by an online advertisement and received from an advertiser is shared with a website operator and a plurality of members, the system includes:

a website operating server displaying an advertisement icon on a specific part of an initial homepage (website), transmitting the advertisement to the advertisement account of the member corresponding to a member range specified by the advertiser, and outputting the advertisement account of the member to a member terminal when the website is logged into while being accessed by the member through the member terminal, and the advertisement icon is clicked;

an advertiser terminal requesting the website operating server to display an advertisement, and then paying an advertisement fee, and specifying and providing the member range that will see the advertisement; and

a member terminal being a member of the homepage (website) operated by the website operating server, sequentially clicking a member icon and the advertisement account to let the member see the advertisement.

### Advantageous Effects

According to the present invention having the above-described characteristics, a total advertisement revenue is shared with a website operator and a member by using an advertisement icon. Thus, an advertiser providing an advertisement, a website operator and a member may have the following effects:

First, according to the present invention, an advertisement effect is maximized by specifying a member range when requesting an advertisement, and an advertisement revenue is reduced by removing unnecessary clicks.

Second, according to the present invention, a website operator may provide an effective advertisement by minimizing hostile of the advertisement and maximizing a click rate of the advertisement.

Third, according to the present invention, an effective advertisement in which a participation of the member is increased and an advertisement revenue is generated whenever the member watches the advertisement may be provided.

Fourth, there is no actual economic value for a conventional advertisement reward amount provided to a member, however, according to the present invention, advertisement revenue is provided as a coupon and prize money is provided to a prizewinner by drawing the coupon, thus an effective advertisement having an actual economic value may be provided.

Fifth, according to the present invention, an effective advertisement in which large variety of choice is provided to a member by immediately changing the coupon to cash according to a cash conversion request may be provided.

In addition, according to the present invention, an effective advertisement in which various types of advertisements are activated by using a communication medium between an advertiser and a member may be provided.

### DESCRIPTION OF DRAWINGS

FIG. 1 is a conceptual view of an online advertisement system according to an embodiment of the present invention.

FIG. 2 is an internal configuration of a website operating server shown in FIG. 1.

FIG. 3 is a flowchart showing an online advertisement method according to an embodiment of the present invention.

FIGS. 4 to 11 are example views of actual outputted screens to help understanding of the present invention.

### BEST MODE

Hereinafter, preferred embodiments of the present invention will be described in detail with reference to the accompanying drawings.

It should be noted that like reference numerals designate like elements although they are shown in different drawings.

In the following description, if it is determined that detailed description of known relevant functions or constructions may unnecessarily obscure the gist of the present invention, the detailed description thereof will be omitted.

Also, the word “comprise”, “comprises”, or “comprising” used throughout the specification will not be understood as the exclusion of the other elements but to imply the inclusion of the other elements.

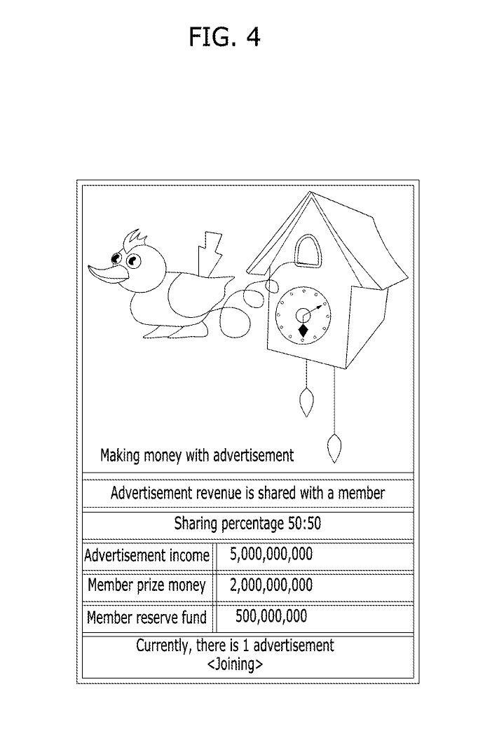

First, for a more complete understanding of the present invention, terms used in the present invention are defined. As shown in FIG. 4, an ‘advertisement icon’ that is configured to integrate a clock, a bird (cuckoo), and blanks for recording an advertisement amount (sharing percentage, advertisement revenue, customer prize money, customer reserve fund), is provided in an initial screen of a homepage. Herein, the clock functions to display a number of advertisements that is provided to a member, the bird functions to inform an arrival of the advertisement by moving and producing an alarm.

The advertisement is exposed to the member when the member clicks the advertisement icon that is provided in the initial webpage.

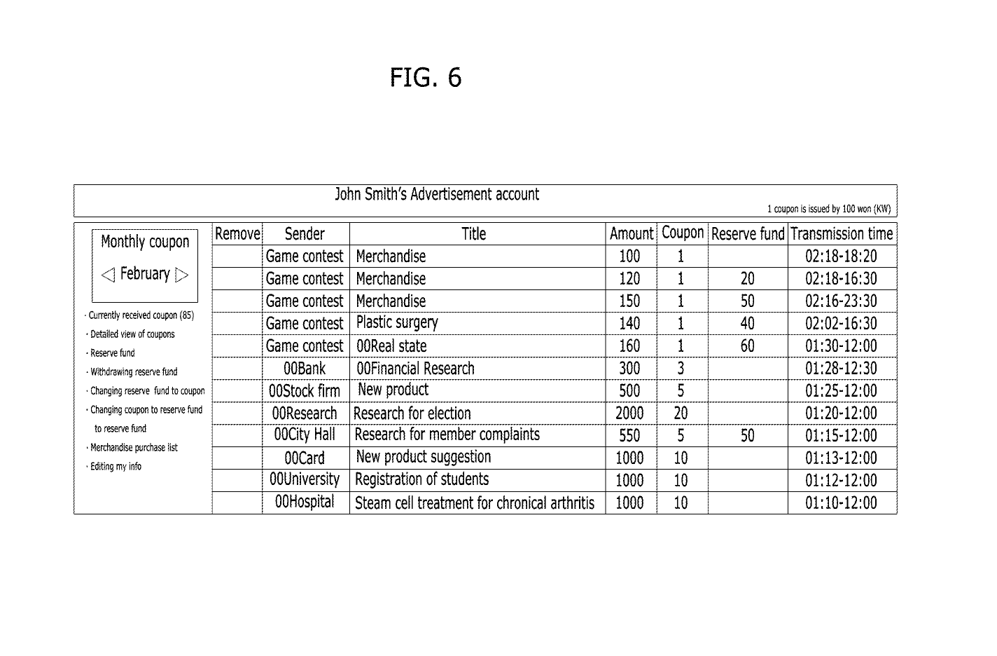

Next, as shown in FIG. 6, an ‘advertisement account’ is used for various information such as storing advertisement data, a reward related to the advertisement, coupon, reserve fund, merchandise purchase, etc., and additional services. A single advertisement account is provided to each member.

The advertisement account is a program used for effectively operating the advertisement of the present invention.

A ‘coupon’ includes serial numbers and a prize money is provided by drawing the coupon.

An advertisement sharing amount of all customers is saved for a predetermined period (for example, from the beginning to the end of every month). Members receive the coupon according to an advertisement revenue that is generated by seeing the advertisement.

For example, 100 won (KW) is set for a coupon. When the member obtains 150 won (KW) by watching the advertisement, then 1 coupon is issued to the member and 50 won (KW) is saved in a reserve fund of the advertisement account of the member.

When the reserve fund exceeds 100 won (KR), then it may be changed to and used as the coupon.

An ‘advertisement sharing percentage’ is a percentage in which an advertisement revenue obtained from the advertisement icon is shared with a website operator and a member.

An ‘customer prize money’ refers to money provided to a prizewinner by drawing coupons that are issued to members by using the reserve funds of all members.

A ‘customer reserve fund’ refers to money that is saved by the remaining reserve fund after issuing the coupon and transferred money changed from the coupon to the reserve fund according to a member's request.

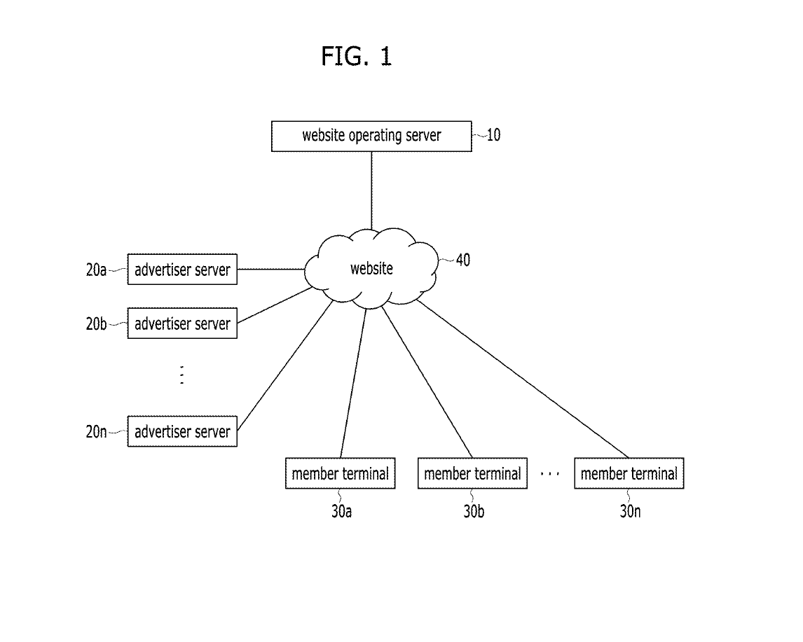

FIG. 1 is a conceptual view of an online advertisement system according to an embodiment of the present invention.

As shown in FIG.1, the online advertisement system includes a website operating server 10, an advertiser server 20a, 20b, . . . , 20n, and a customer terminal 30a, 30b, . . . , 30n.

The advertiser server 20a, 20b, . . . , 20n, requests an online advertisement to the website operating server 10 and promises to pay an advertisement revenue for the advertisement. Herein, the advertiser server 20a, 20b, . . . , 20n, determines a member range that will see the advertisement and notifies the website operating server 10 of the member range.

Herein, the advertisement may be produced by the advertiser server 20a, 20b, . . . , 20n, and provided to the website operating server 10. Alternatively, the advertisement may be produced by the website operating server 10 according to a request of the advertiser server 20a, 20b, . . . , 20n.

When the member terminal 30a, 30b, . . . , 30n accesses a website (homepage) 40 operated by the website operating server 10 and clicks an advertisement icon, a corresponding advertisement is exposed to the member terminal 30a,, 30b, . . . , 30n and a coupon is issued to the member terminal 30a, 30b, . . . , 30n, then the advertiser server 20a, 20b, . . . , 20n pays the promised advertisement revenue to the website operating server 10.

The website operating server 10 operates the homepage (website) 40 and advertises the required advertisement of the advertiser online. The website operating server 10 may install an advertisement icon in an initial screen of the website (homepage) 40 and manage advertisements in an integrated manner.

Herein, as shown in FIG. 4, the advertisement icon is provided integrating the clock that displays the number of advertisements provided to the customer, the bird (cuckoo) that notifies the arrival of the advertisement to the member by moving and producing an alarm, and blanks for recording the advertisement amount (sharing percentage, advertisement revenue, customer prize money, customer reserve fund).

The advertisement icon displays a total advertisement revenue, customer prize money, a customer reserve fund, etc. in a lower part thereof in real-time to ensure transparency for advertisement revenue management.

In addition, the website operating server 10 initially outputs an advertisement revenue sharing agreement to the member terminal 30a, 30b, . . . , 30n for the first time and shares the advertisement revenue with the member according to the agreement in a fixed percentage.

The advertisement revenue sharing agreement may include contents such as ‘The member provides information such as region, age, sex, job of the member to the website operating server 10, and the website operating server 10 provides a M predetermined percentage of the advertisement revenue obtained by providing the advertisement to the member. The advertisement revenue sharing corresponds to all advertisements transmitted to the advertisement account of the member. The advertisement account is displayed by clicking the advertisement icon installed in the homepage. The advertisement revenue provided to the member is provided in a coupon, and a prize money is provided to a prizewinner by drawing coupons. The coupon may be exchanged for cash at any time before drawing the coupons. The advertisement revenue sharing percentage, the advertisement revenue, the customer prize money, the customer reserve fund, etc. are displayed in a lower part of the advertisement icon in real-time. Member information is used for advertisement purposes in a limited extent’.

Herein, in order to ensure fairness of the drawing, the advertisement icon may include content such as ‘The coupon is issued to have the same numerals as an annuity lottery and a prizewinner is determined based on winning numbers of the first annuity lottery after the coupon being issued’.

The member agrees the advertisement revenue sharing agreement by annessing the website 40 through the member terminal 30a, 30b, . . . , 30n, signs up for a membership by providing personal information such as region, age, sex, job, etc. and inputting an ID and a password.

Herein, the member may provide advertisement information that will be provided to him or her to the website operating server 10 by selecting or inputting an advertisement range.

Thus, the website operating server 10 may specify a proper member by matching the member range notified from the advertiser and the advertisement rage of the member and provide the advertisement to the advertisement account of the corresponding member.

The website operating server 10 assigns a single advertisement account to each member, when the member accesses and logs into the website 40 and clicks the advertisement icon through the member terminal 30a, 30b, . . . , 30n, the website operating server 10, as shown in FIG. 6, outputs an advertisement account of the corresponding member to the member terminal 30a, 30b, . . . , 30n so that the member may receive a coupon by clicking an advertisement that is appropriate for him or her.

In addition, the website operating server 10 changes the coupon issued to the member to a reserve fund when the member requests through the member terminal 30a, 30b, . . . , 30n before drawing the coupon, and transfers the reserve fund to the advertisement account of the member. Alternatively, the website operating server 10 change's the reserve fund to a coupon according to a member's request such that the member may become a subject of a prizewinner.

The website operating server 10 issues a coupon and selects the prizewinner associating with an authorized annuity lottery to ensure fairness of the drawing.

For example, coupons are issued from the first to the end of every month. Entry numbers of the coupon are issued to have the same numerical order as the annuity lottery. Every 6.3 millions of coupons is set as a single set and coupons are continuously issued until to reach the single set. Prizewinners are selected at the beginning of the next month after finishing issuing the coupons at the end of every month. Winning numbers is the same until hundreds digits as the first winning numbers of the annuity lottery. Prizewinners are selected up to 200 persons for each set. When there are no winning numbers, the coupon is changed to the reserve fund. The prize money is provided to each prizewinner by dividing the total amount of the prize money into the number of prizewinners. In addition, there is no limit for the receipt period of the prize money.

Thus, the website operating server 10 finishes issuing the coupon, issues winning numbers of the first prizewinner, and provides the prize money by confirming the prizewinner corresponding to the a selection standard of the prizewinner.

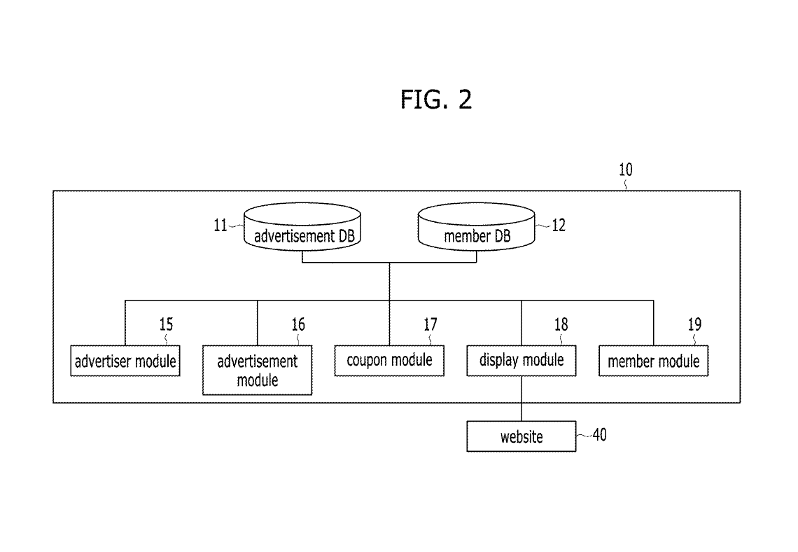

FIG. 2 is an internal configuration of a website operating server shown in FIG. 1.

As shown in FIG. 2, the website operating server 10 operates and manages an advertisement DB 11 and a member DB 12, and includes an advertiser module 15, an advertisement module 16, a coupon module 17, a display module 18, and a member module 19.

The advertisement DB 11 stores an advertiser, respective advertisement data requested by the advertiser, and a member range including members that wants to see the advertisement, etc.

The member DB 12 stores personal information of the member such as region, age, sex, job, ID, password, etc. and an advertisement range that the member wants to see.

The advertiser module 15 manages advertiser information, advertiser sales, an advertiser category, an advertisement reservation, an advertisement suspension/cancellation, etc.

The advertisement module 16 manages advertisement fees, an advertisement category, a payment of the advertisement fees, a bank statement of the advertiser, a total declared value of the advertisement, a total declared value of the prize money, a customer reserve fund, etc.

The coupon module 17 manages issuing a coupon, selecting a prizewinner, a prizewinner, a transmission of winning numbers, etc.

The display module 18 manages a clock operation and a bird operation, and displays a sharing percentage, a total advertisement revenue, prize money, a reserve fund, etc.

The member module 19 manages an advertisement account, a W member category, an advertisement transmission, a prizewinner, etc.

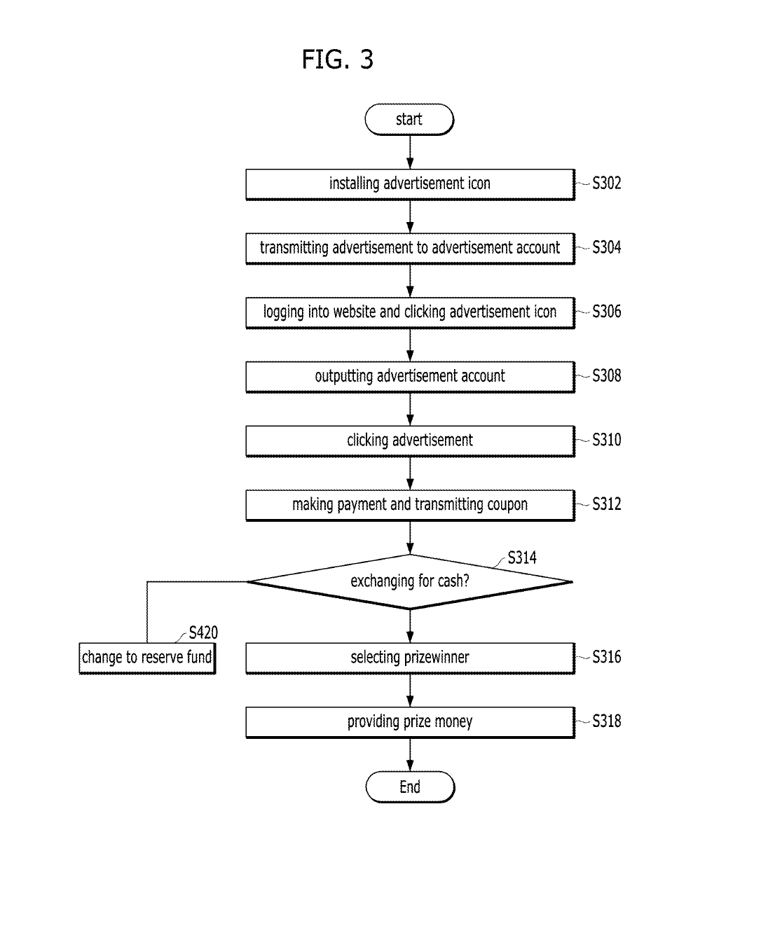

FIG. 3 is a flowchart showing an online advertisement method according to an embodiment of the present invention.

First, a website operating server 10 receives an online advertisement request from an advertiser and notifies a selection condition of issuing a coupon related to the advertisement and a prizewinner. A member (member) watches the selection condition of issuing the coupon and the prizewinner trough a member terminal 30a, 30b, . . . , 30n and signs up for a membership when the member is interested in the notification by inputting personal information. Then, the website operating server 10 assigns a single advertisement account for each member.

Herein, as shown in FIG. 6, the advertisement account is configured to be used for various information such as advertisement data, reward related to the advertisement, coupon, reserve fund, merchandise purchase information, and for an additional service.

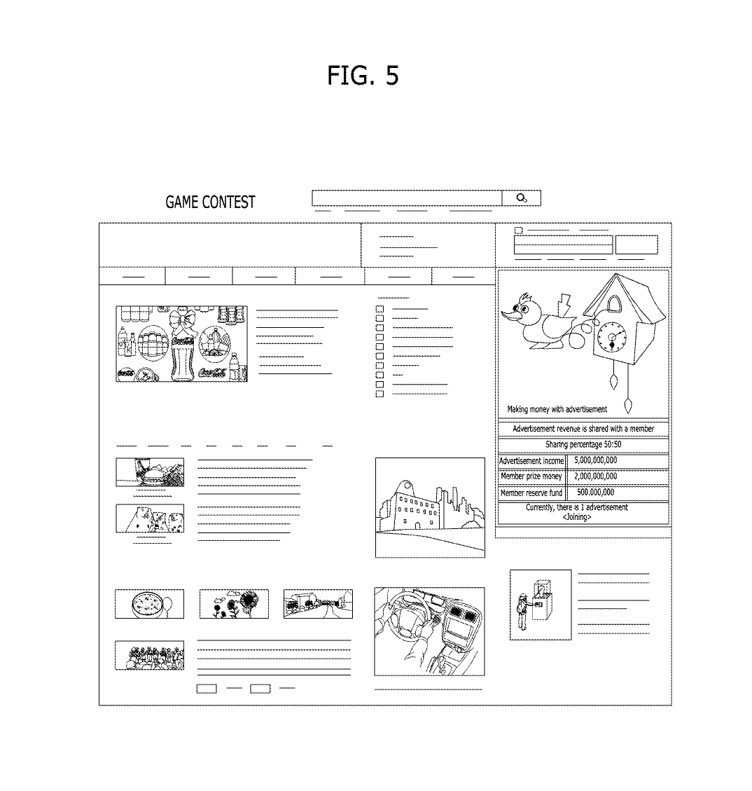

The website operating server 10 installs an advertisement icon in a proper position of an initial homepage (website) 40 that is operated thereof (Refer to FIG. 5) (S302).

Herein, as shown in FIG. 4, the advertisement icon is configured to integrate the clock, the bird (cuckoo) and the blanks for recording an advertisement amount (sharing percentage, advertisement revenue, member prize money, member reserve fund).

In addition, the website operating server 10 transmits advertisement data to the advertisement account of the corresponding member that is proper for the advertisement (S304).

The member accesses the initial homepage 40, logs into the homepage 40 by inputting an ID and a password through the member terminal 30a, 30b, . . . , 30n. When the member clicks the advertisement icon through the member terminal 30a, 30b, . . . , 30n (S306), the website operating server 10 outputs the advertisement account of the member to the member terminal 30a, 30b, . . . , 30n (S308).

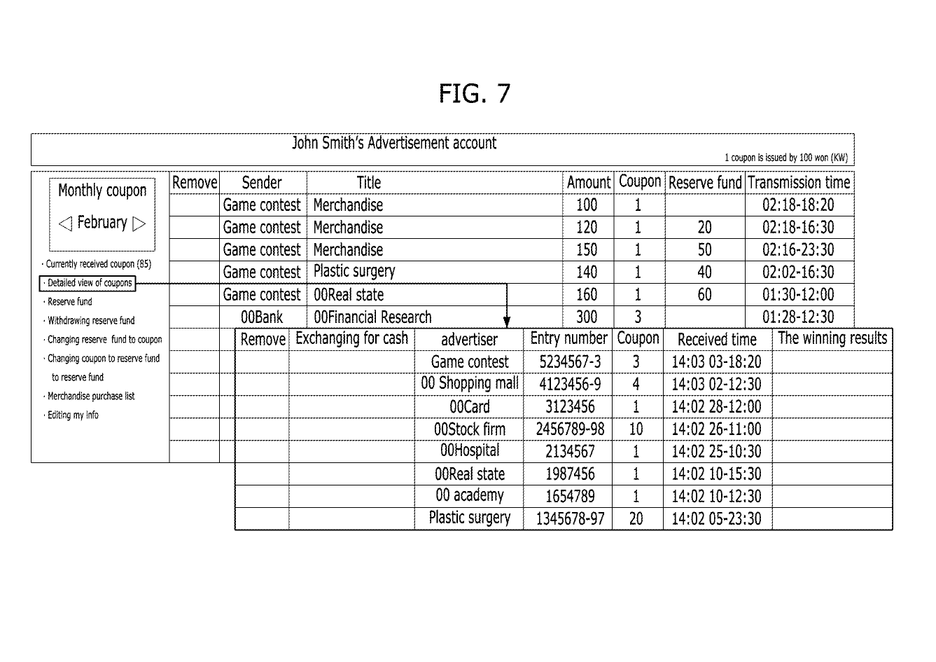

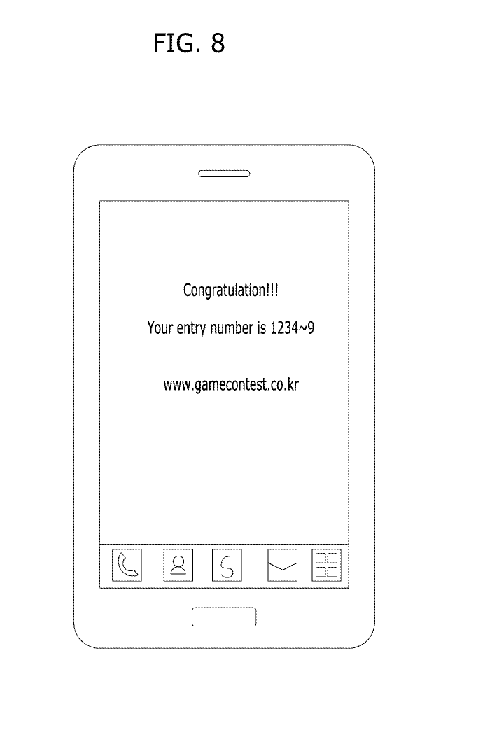

When the member clicks the advertisement of the advertisement account outputted to the member terminal 30a, 30b, . . . , 30n (S310), the website operating server 10 makes a payment, issues a coupon that is issued with a predetermined amount within a payment amount, transmits the coupon to the advertisement account (Refer to FIG. 7) and the member terminal 30a, 30b, . . . , 30n (Refer to FIG. 8), and transfers the remaining amount of payment to the reserve fund (S312).

For example, when the member obtains 150 won (KW) as a payment of seeing the advertisement and the coupon is issued in a unit of 100 won (KW), then 1 coupon is issued and the remaining 50 won (KW) is transferred to the reserve fund of the W advertisement account of the member.

Herein, details of the payment are displayed in the advertisement icon of the homepage 40 in real time.

Then, a prizewinner is selected by drawing the coupon associating with, for example, an annuity lottery in a lottery day (S316), and provides corresponding prize money to the prizewinner (S318).

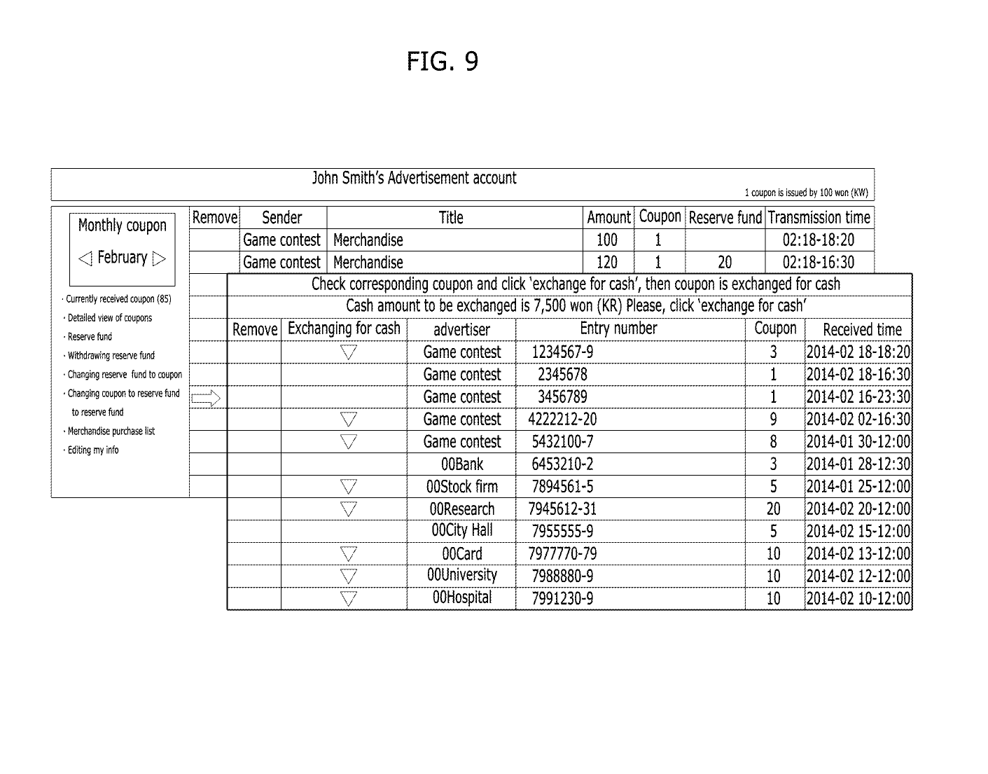

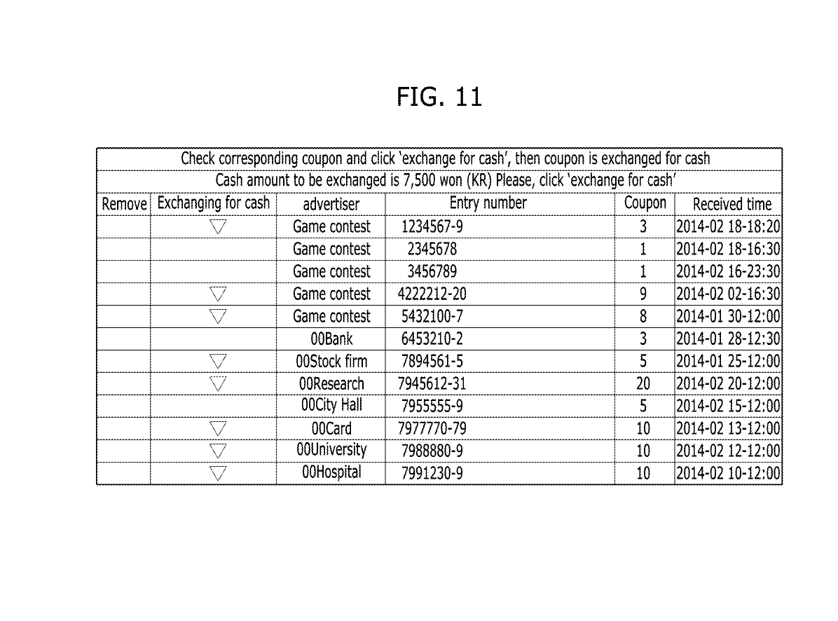

Herein, when a cash conversion request of the coupon issued and transmitted to the advertisement account of the member is received from the member terminal 30a, 30b, . . . , 30n (Refer to FIGS. 9 and 11) (S314) before drawing the coupon, an amount corresponding to the coupon is changed to the reserve fund and transferred to the advertisement account (S320).

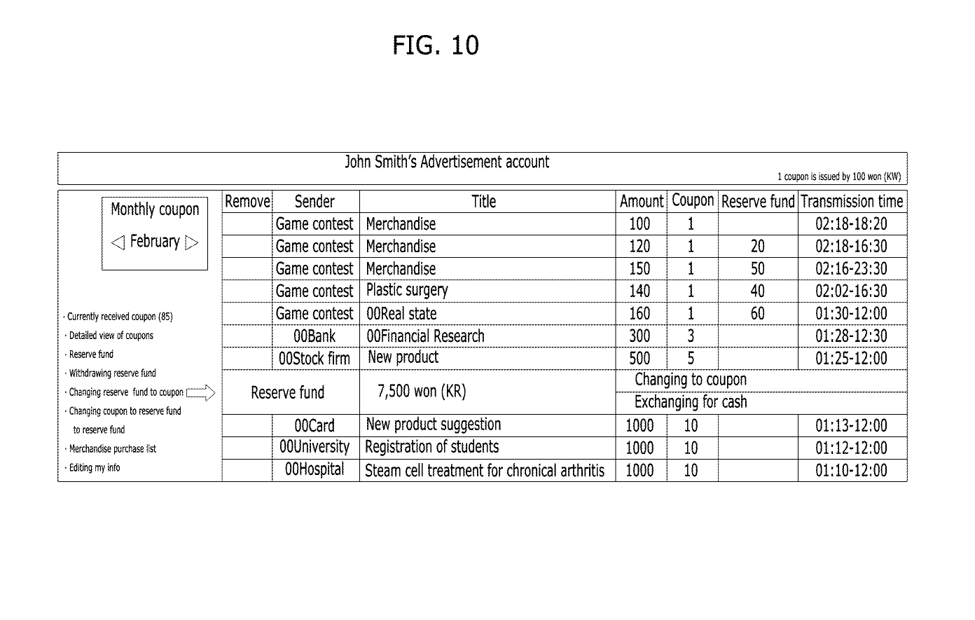

Such reserve fund may be changed to a coupon according to a member's request (Refer to FIG. 10). In addition, the reserve fund may be exchanged for (withdrawn in) cash and be used for purchasing merchandise.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the exemplary embodiments should be considered in a descriptive sense only and not for purposes of limitation. The scope of the present invention may be claimed by the claims rather than the detailed descriptions of the invention, and all changes or modifications from the meaning and scope and equivalents of the claims should be included within the scope of the present invention.

1. An online advertisement method, whereby advertisement revenue generated by an online advertisement and received from an advertiser is shared with a website operator and a plurality of members, the method being performed by a website operating server and comprising:
(a) displaying an advertisement icon on a specific part of an initial online homepage(website);
(b) assigning a single advertisement account to a member who wants to receive the advertisement revenue by accessing the initial homepage (website) through a member terminal and seeing the advertisement;
(c) transmitting the advertisement to the advertisement account of the member corresponding to a member range the member range being a range of members that will see the advertisement required from the advertiser; and
(d) outputting the advertisement account of the member to the member terminal when the member terminal has accessed the initial homepage and has clicked the advertisement icon after logging into the homepage;
(e) making a payment, and issuing and transmitting a coupon to the advertisement account of the member when the advertisement of the advertisement icon is clicked by the member terminal;
(f) selecting a prizewinner by drawing the coupon, and providing a corresponding prize money to the prizewinner; and
(g) changing the coupon to a reserve fund and transferring the changed reserve fund to the advertisement account of the member when receiving a cash conversion request W from the member terminal before drawing the coupon, wherein
in the displaying the advertisement icon, in order to ensure fairness of advertisement revenue management, the website operating server displays an advertisement sharing percentage (website operating server and member), an advertisement revenue, a member prize money, and a member reserve fund in a lower part of the advertisement icon in real time, wherein the advertisement account includes advertisement data, a reward related to the advertisement, a coupon, a member reserve fund, and merchandise purchase information, and
in the assigning the advertisement account, the member accessing the website agrees on an advertisement revenue sharing agreement, registers for membership, and provides advertisement information by inputting or selecting a desired advertisement range through the member terminal.

2. (canceled)

3. (canceled)

4. (canceled)

5. The method of claim 1, wherein the website operating server issues the coupon to have numerals similar to a lottery system by interworking with an authorized lottery system, and selects as a member who has the coupon with the same winning numbers of the lottery system, as the prizewinner.

6. The method of claim 1, wherein in the making the payment and issuing the coupon, the website operating server issues the coupon within a payment amount and changes the remaining amount to the reserve fund.

7. (canceled)

8. An online advertisement system, whereby an advertisement revenue generated by an online advertisement and received from an advertiser is shared with a website operator and a plurality of members, the system comprising:
a website operating server displaying an advertisement icon on a specific part of an initial homepage(website), assigning a single advertisement account to a member, transmitting the advertisement to the advertisement account of the member corresponding to a member range notified from the advertiser, and outputting the advertisement account of the member to a member terminal when the member terminal has accessed the initial homepage and has clicked the advertisement icon after logging into the homepage;
an advertiser terminal requesting an online advertisement to the website operating server, paying an advertisement revenue, and specifying and providing the member range that will see the advertisement to the website operating server; and
a member terminal being a member of the homepage (website) operated by the website operating server, accessing the website, agreeing with advertisement revenue sharing agreement, registering for a membership, providing advertisement information to the website operating server by inputting or selecting an advertisement range that the member wants to see, and sequentially clicking the advertisement icon and the advertisement account to let the member see the advertisement, wherein
the website operating server, in order to ensure fairness of advertisement revenue management, displays integrated information including a clock displaying a number of advertisements provided to the member, a bird informing the member an arrival of the advertisement by moving and producing an alarm, and advertisement information including an advertisement revenue, a member prize money, a member reserve fund, and changes a coupon to a reserve fund when receiving a cash conversion request from the member terminal and transfers the reserve fund in the advertisement account of the member, or changes the reserve fund to the coupon, and
the advertisement account includes advertisement data, a reward related to the advertisement, the coupon, a member reserve fund, and merchandise purchase information.

9. (canceled)

10. (canceled)

11. The system of claim 8, wherein the website operating server makes a payment when the advertisement is seen by the member terminal through clicking the advertisement account, issues a coupon interworking with an authorized lottery system, and transmits the coupon to the advertisement account of the member, and selects a prizewinner by drawing the coupon and providing a corresponding prize money to the prizewinner.

12. (canceled)
